(19) United States
(12) Patent Application Publication
(10) Pub. No.: US 2011/0173061 A1
(43) Pub. Date: Jul. 14, 2011

(54) SYSTEM FOR MOBILE REWARDS

(75) Inventors: Jeffrey Anulewicz, Commerce, MI (US); Douglas Rozen, Minnetonka, MN (US); Andrew Wright, Edina, MN (US)

(73) Assignee: Carlson Marketing Worldwide, Inc., Plymouth, MN (US)

(21) Appl. No.: 12/684,403

(22) Filed: Jan. 8, 2010

(51) Int. Cl. G06Q 30/00; G06K 19/06; H04W 4/12; H04M 1/00; G06F 15/16

(52) U.S. Cl. 705/14.33; 705/14.38; 235/494; 455/466; 455/556.1; 709/206

(57) ABSTRACT

In an example embodiment, there is a system for mobile reward redemption. The system may receive a selection of a cash equivalent rewards on a mobile device. The system may further transmit a request message from the mobile device to a reward fulfillment server, wherein the request message comprises the selection of the cash equivalent reward. Additionally, the system may receive a message on the mobile device from the reward fulfillment server comprising a link to a barcode image. The barcode image may represent the cash equivalent reward. The barcode image may be retrieved and the barcode image may be presented to a merchant scanning system to redeem the cash equivalent reward.

### BACKGROUND

Customers participate in loyalty reward programs to accumulate points based on various activities associated with the maintaining entity. These points may be redeemed at participating locations for cash or cash-equivalents.

### BRIEF DESCRIPTION OF THE DRAWINGS

Some embodiments are illustrated by way of example and not limitation in the figures of the accompanying drawings in which:

FIG. 1 is a network diagram illustrating a system to obtain a cash equivalent, according to an example embodiment;

FIG. 2 illustrates a matrix of possible redemption methods for cash equivalents, according to an example embodiment;

FIG. 3 illustrates a block diagram of a user device, according to an example embodiment;

FIG. 4 illustrates an example data flow diagram of obtaining a cash equivalent, according to an example embodiment, and

FIG. 5 illustrates an example user interface of a mobile catalog, according to an example embodiment.

FIG. 6 illustrates an example computer system, according to an example embodiment.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. The following detailed description is, therefore, not to be taken in a limiting sense, and the scope of the present invention is defined by the appended claims and their equivalents. In this document, the terms “a” or “an” are used, as is common in patent documents, to include one or more than one. In this document, the term “or” is used to refer to a nonexclusive or, unless otherwise indicated.

Loyalty programs allow participants to accumulate rewards points which are redeemed later for goods or services. For example, consider the situation in which a participant is enrolled in a loyalty program for a retail store. Points are accumulated when the participant purchases goods at the retail store or affiliate stores. A rewards catalog allows the participant to redeem these points for various goods or services. In some cases, these rewards are cash-equivalents such as gift cards or discount cards and the following descriptions will use this as the underlying example. In an example embodiment, one goal of the present subject matter is to decrease the amount of time and effort a participant uses in order to redeem his or her points. In some instances, difficulties arise because a participant does not have a quick way to redeem points in an instantaneous manner. This can lead to a reduction in the use of the loyalty program. Another goal of various example embodiments is to reduce the possibility of participants and merchants having to acquire new equipment.

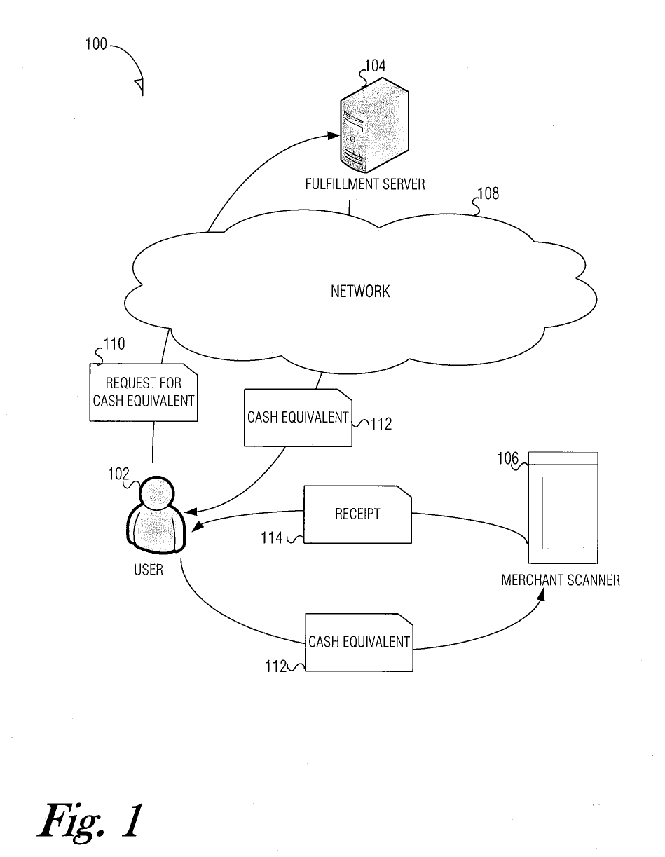

FIG. 1 illustrates an example system diagram 100 according to the present subject matter. Illustrated is a use case with user 102 interacting with fulfillment server 104 and merchant scanner 106 through network 108. Network 108 may be a network such as the Internet or a phone network (land line, Global System for Mobile Communications (GSM), CDMA, etc.) In an embodiment, user 102 is a participant in a loyalty rewards program utilizing a user device to transmit a request for cash equivalent 110 to fulfillment server 104. Fulfillment server 104 processes the request and sends cash equivalent 112 to the user device. User 102 displays cash equivalent 112 to merchant scanner 106. Receipt 114 is generated and received by user 102. In various embodiments, an employee at a merchant location may manually enter the information from the cash equivalent.

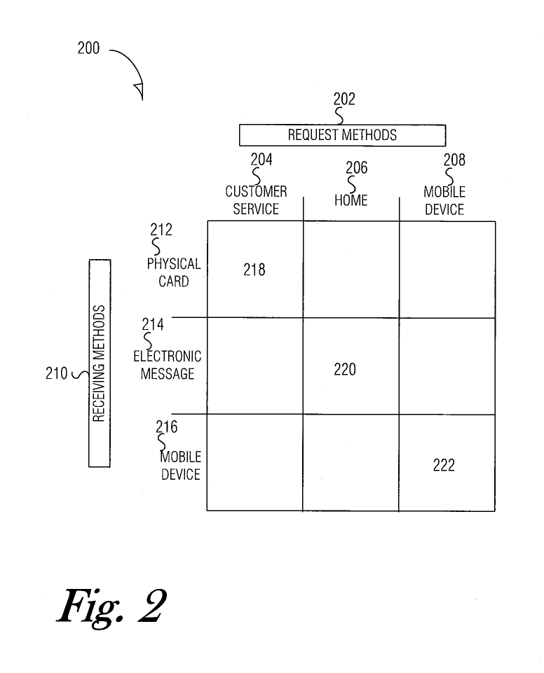

FIG. 2 illustrates a matrix table depicting various example methods in which a user can communicate with a fulfillment server such as described in FIG. 1. Column request methods 202 include customer service 204, home 206, and mobile device 208. Row receiving methods 210 include physical card 212, e-mail 214, and mobile device 216. Intersections 218, 220, and 222 represent some of the available combinations between request methods 202 and receiving methods 210. While not discussed in detail, the non-labeled intersections are valid combinations of requesting methods and receiving methods.

Intersection 218 is the combination of customer service 204 and physical card 212. In an embodiment, customer service refers to a method where a participant calls and places an order over the phone to redeem his or her loyalty points. Physical card refers to the receiving method where a cash-equivalent card (gift card, etc) is mailed through one or more carriers (United States Postal Service, UPS, FedEx, etc). Intersection 218 is therefore a method which may not lend itself to quick or efficient redemption of points. There may be a delay of days between when a participant places an order for a cash-equivalent and when a physical card is actually received.

Intersection 220 is the combination of the home 206 requesting method and the e-mail receiving 214 method. Home refers to a participant browsing an electronic version of a reward catalog at a stationary computing device (e.g., personal computer). The participant can see his or her remaining point balance and the availability of various cash-equivalent rewards. In various embodiments, the reward catalog is stored on a fulfillment server. The participant selects, using an input device, one or more rewards from the reward catalog and the reward is delivered electronically to an e-mail address of the participant. The e-mail may be printed out and brought to a merchant and scanned on existing technology (barcode readers). This requesting and receiving combination allows a participant to enjoy his or her reward faster than intersection 218.

Intersection 222 is the combination of the mobile device requesting method 208 and the mobile device receiving method 216. In various embodiments, a participant will carry a mobile device in which a mobile version of the rewards catalog is accessed. Using the mobile device, the participant will select one or more cash-equivalent rewards from the rewards catalog. In an embodiment, the rewards catalog is stored on a fulfillment server. The fulfillment server will process the request and send a response back to the mobile device. The response may take many forms. For example, it may be a short messaging service (SMS) message containing a link to a picture (barcode) of the reward or a multimedia messaging service (MMS) message of the reward. This described system using only a mobile device make redeeming points nearly effortless. By removing the time delay (as compared to the methods) a participant may be in a merchant store and decide to redeem his or her points to obtain a discount at the merchant. Instead of needing to wait days, the cash-equivalent reward is delivered almost instantly.

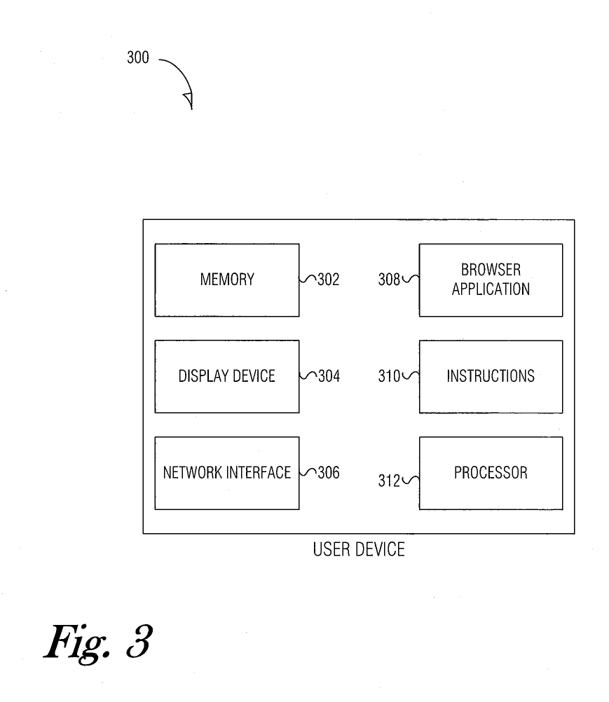

FIG. 3 illustrates a block diagram of user device 300. In various embodiments a user device is a mobile device or personal digital assistant (PDA). In an embodiment, user device 300 includes components of memory 302, display device 304, network interface 306, browser application 308, instructions 310, and processor 312. In various embodiments, these components are communicatively coupled to each other and may be combined. For example, instructions 310 may be stored in memory 302. The instructions may be executed by processor 312 to implement the methods described above.

In an embodiment, a mobile rewards catalog is received through network interface 306 and displayed on display device 304 using browser application 308. The network interface is configured to be responsive to a plurality of network protocols such as, but not limited to, TCP/IP, CDMA2000, GSM, SMS, and MMS. The browser application may receive user input using a touch-screen, input buttons (e.g., alphanumeric keyboard), or stylus.

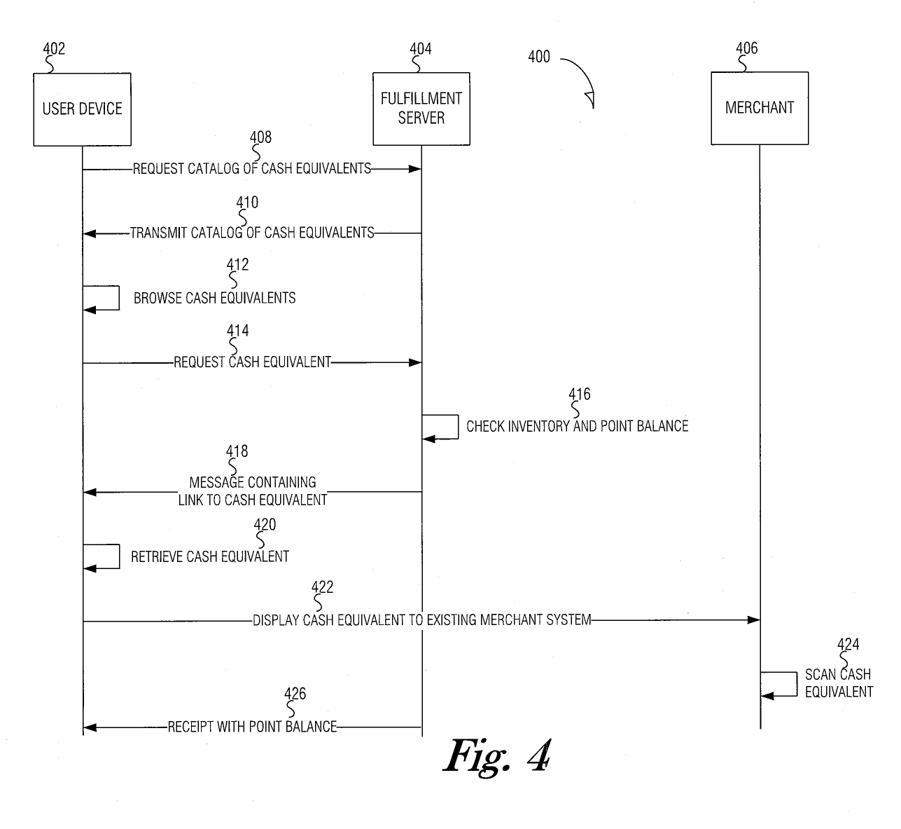

FIG. 4 illustrates an example flow chart 400 of communications and processing between user device 402, fulfillment server 404, and merchant 406. In an embodiment user device 402 contains at least the components of user device 300. Fulfillment server 404 may include at least a processor, a memory, and a network interface. In various embodiments, the processing of requests from user devices at the fulfillment server may be distributed across multiple machines. In some embodiments, the fulfillment server is maintained by a party different than the administrator of the loyalty rewards program.

At communication 408, a request is made from user device 402 to fulfillment server 404 for a rewards catalog of cash-equivalents. The fulfillment server 404 processes the request and, in communication 410, transmits the catalog of cash-equivalents back to user device 402. In an embodiment, the user device communicates with the fulfillment server using the Hypertext Transfer Protocol (HTTP). In various embodiments a secure version of HTTP is utilized (HTTPS). In an embodiment, the request for the catalog includes identifying information which the fulfillment server processes. The identifying information allows the fulfillment server to determine which cash-equivalents are available to the user. In some embodiments, further information is solicited from the user in order to verify that the user requesting the catalog is the same user that participates in a loyalty program.

At processing step 412, a user browses the catalog of cash-equivalents on the display device of the user device. In various embodiments, the catalog includes information about each cash-equivalent. For example, it will include the points required in order to receive the cash-equivalent and where the cash-equivalent may be used. Upon a user deciding on what cash-equivalent to purchase with his or her points, a selection of the cash equivalent reward is received on the user device.

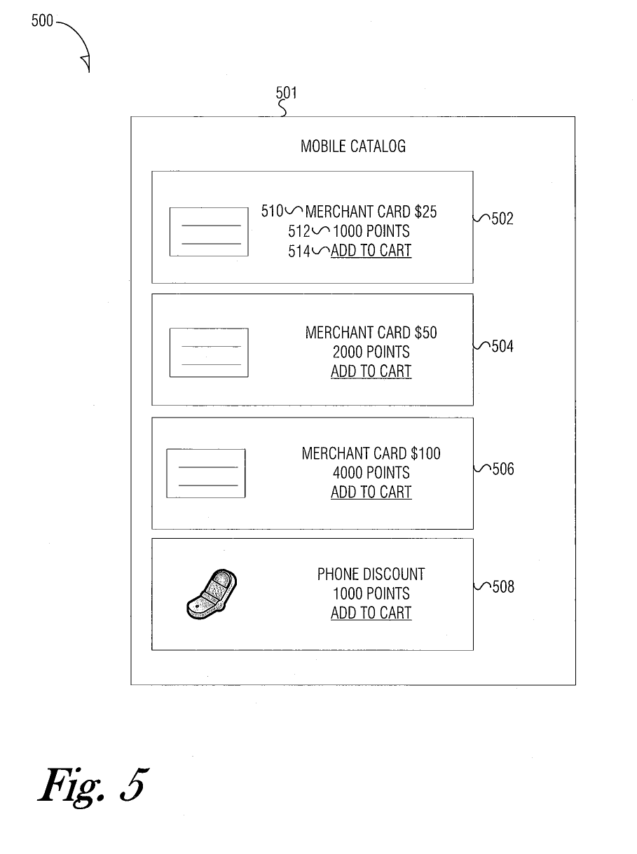

FIG. 5 illustrates an example user interface of a mobile catalog 500 according to an example embodiment. Illustrated are cash equivalents 502, 504, 506, and 508 which are displayed on a display device of a mobile device 501. Each cash equivalent has a description 510, the amount of points it takes to redeem 512, and an activation button 514 to select the cash equivalent for redemption. As illustrated, cash equivalent 502 is for a merchant card worth $25 which uses 1000 points. In various embodiments more than one cash equivalent may be redeemed at the same time as illustrated by the “ADD TO CART” activation button 514. Upon selecting one more cash equivalents for redemption the process may continue at communication 414 in FIG. 4.

At communication 414, a request message is transmitted from user device 402 to fulfillment server 404. In various embodiments, the request is first processed by the same server that sent the mobile catalog and then sent to a second server for redemption (sending the cash-equivalent to the user device). In other embodiments, the request is processed and redeemed at the same server.

In an example embodiments, the request is formatted in extensible markup language (XML). The data needed in the XML request may include, but is not limited to:

```
<Merchant>
  CustID: Username for customer access to system
  Password: Password for system access
<Content>
  Phone: Phone number of recipient
  Action: Action to be performed during transaction (Send)
  CardID: Unique number identifying card in inventory
  ItemNum: Value
  OrderNum: Value
  OrderLineNum: Value
  ProgramText: Additional text for SMS Body
```

An example XML message may look like

```
<?xml version=“1.0” encoding=“UTF-8” standalone=“no”?>
<XMLRequest>
  <Merchant>
    <CustID>XXXXXXXXX</CustID>
    <Password>XXXXXXX</Password>
  </Merchant>
  <Content>
    <Phone>5551235432</Phone>
    <Action>Send</Action>
    <CardID>2881</CardID>
    <ItemNum>XXXX</ItemNum>
    <OrderNum>XXXX</OrderNum>
    <OrderLineNum>XXXX</OrderLineNum>
    <ProgramText>Here is your Merchant Gift Card</ProgramText>
  </Content>
</XMLRequest>
```

At processing block 416, fulfillment server checks the inventory of cash-equivalents and the point balance of the user. In an embodiment, the fulfillment server maintains an inventory of already activated cash-equivalent cards. This data may be stored in the memory of the fulfillment server in one or more databases or files. For example, a fulfillment server may maintain an inventory of 30 gift cards of $10 value to merchant A and 20 gift cards of $50 to merchant A, and 15 gift cards of $20 to merchant B. The fulfillment server will process the request from the user device by decrementing its inventory for the requested cash-equivalent if the user has enough points to purchase the cash-equivalent. Additionally, the fulfillment server will decrement the available points to the user. In an example embodiment, a database is maintained of users participating in a loyalty program with their accompanying points. This user data may be stored on the same machine which processes the request or on an external machine. A receipt of the transaction including available points may be sent to the user after processing the request for the cash-equivalent reward (e.g., communication 426). In various embodiments, cash-equivalent accounts are maintained at the merchant level with an account key or other pointer located in the fulfillment server.

At communication 418, a message is sent from the fulfillment server to the user device, wherein the message includes a link to a barcode image, wherein the barcode image represents the cash equivalent reward. In an embodiment, the message is received at the user device in the form an SMS message. In further embodiments, a message is received at the user device as a MMS which contains the barcode. Additional information (e.g., an alphanumeric identification of the cash-equivalent) may also be received at the user device that facilitates the use of the cash-equivalent at a merchant's scanning system. The barcode is configured to interface with existing merchant scanning systems. If the merchant's scanning system does not recognize the barcode image, the operator of the scanning system may manually enter in the alphanumeric characters included in the received message. At processing step 424, the cash-equivalent (in the form of a barcode) is presented to a merchant's scanning system. In various embodiments, the barcode image that is received is configured to be useable by the merchant's existing scanning systems.

Distributed Computing Components

Some example embodiments may include the previously illustrated components (e.g., operations) being implements across a distributed programming environment. For example, operations providing logic functionality may reside on a first computer system that is remotely located from a second computer system containing an Interface or Storage functionality. These first and second computer systems can be configured in a server-client, peer-to-peer, or some other configuration. These various levels can be written using the above illustrated operation design principles and can be written in the same programming language, or a different programming language. Various protocols are implemented to enable these various levels, and operations contained therein, to communicate regardless of the programming language used to write these operations. For example, a module written in C++ using the Common Object Request Broker Architecture (CORBA) or Simple Object Access Protocol (SOAP) can communicate with another remote module written in Java. These protocols include SOAP, CORBA, or some other suitable protocol. These protocols are well-known in the art.

A System of Transmission Between a Server and Client

In some embodiments, the above illustrated operations that make up the platform architecture communicate using the Open Systems Interconnection Basic Reference Model (OSI) or the Transmission Control Protocol/Internet Protocol (TCP/IP) protocol stack models for defining network protocols that facilitate the transmission of data. Applying these models, a system of data transmission between a server and client computer system can be illustrated as a series of roughly five layers comprising as a: physical layer, data link layer, network layer, transport layer and application layer. Some example embodiments may include the various levels (e.g., the Interface, Logic and storage levels) residing on the application layer of the TCP/IP protocol stack. The present application may utilize HTTP to transmit content between the server and client applications, whereas in other embodiments another protocol known in the art is used. Content from an application residing at the application layer is loaded into the data load field of a TCP segment residing at the transport layer. This TCP segment also contains port information for a recipient application or a module residing remotely. This TCP segment is loaded into the data field of an IP datagram residing at the network layer. Next, this IP datagram is loaded into a frame residing at the data link layer. This frame is then encoded at the physical layer and the content transmitted over a network such as the Internet, Local Area Network (LAN) or Wide Area Network (WAN). The term Internet refers to a network of networks. Such networks may use a variety of protocols for exchange of information, such as TCP/IP etc., and may be used within a variety of topologies or structures. This network may include a Carrier Sensing Multiple Access Network (CSMA) such as an Ethernet-based network. This network may include a Code Division Multiple Access (CDMA) network or some other suitable network.

A Computer System

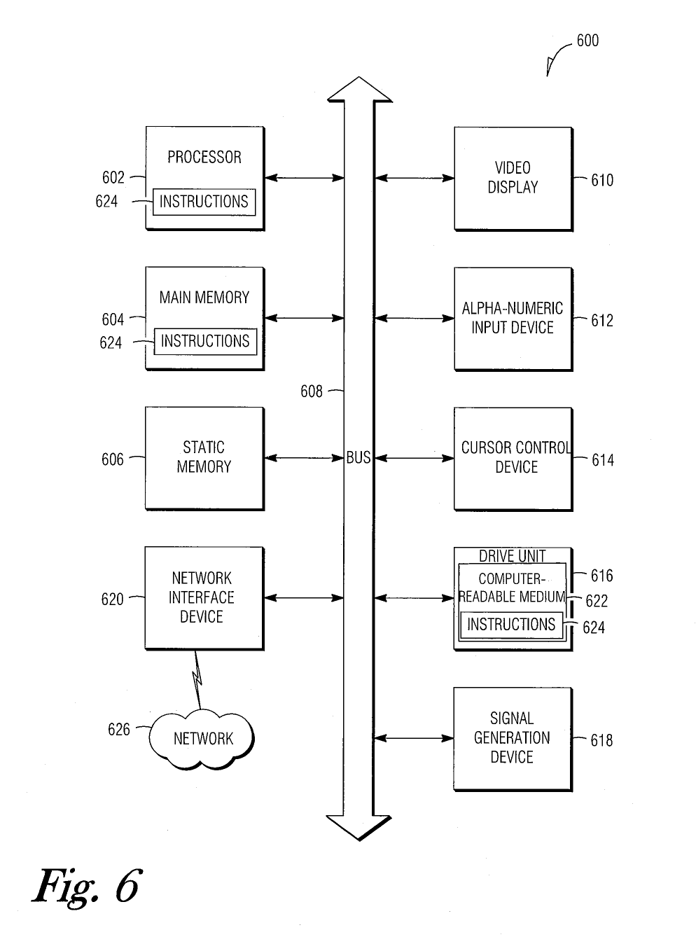

FIG. 6 shows a diagrammatic representation of a machine in the example form of a computer system 600 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 600 includes a processor 602 (e.g., a Central Processing Unit (CPU), a Graphics Processing Unit (GPU) or both), a main memory 604 and a static memory 606, which communicate with each other via a bus 608. The computer system 600 may further include a video display unit 610 (e.g., a Liquid Crystal Display (LCD) or a Cathode Ray Tube (CRT)). The computer system 600 also includes an alphanumeric input device 612 (e.g., a keyboard), a User Interface (UI) cursor controller 614 (e.g., a mouse), a disk drive unit 616, a signal generation device 618 (e.g., a speaker) and a network interface device 620 (e.g., a transmitter).

The disk drive unit 616 includes a machine-readable medium 622 on which is stored one or more sets of instructions and data structures (e.g., software) embodying or used by any one or more of the methodologies or functions illustrated herein. The software may also reside, completely or at least partially, within the main memory 604 and/or within the processor 602 during execution thereof by the computer system 600, the main memory 604 and the processor 602 also constituting machine-readable media.

The instructions 624 may further be transmitted or received over a network 626 via the network interface device 620 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

It is to be understood that the above description is intended to be illustrative, and not restrictive. For example, the above-illustrated embodiments (and/or aspects thereof) may be used in combination with each other. Many other embodiments may be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

What is claimed is:

1. A method comprising:
receiving a selection of a cash equivalent reward on a mobile device;
transmitting a request message from the mobile device to a reward fulfillment server, wherein the request message comprises the selection of the cash equivalent reward;
receiving a message on the mobile device from the reward fulfillment server comprising a link to a barcode image, wherein the barcode image represents the cash equivalent reward;
retrieving the barcode image; and
presenting the barcode image to a merchant scanning system to redeem the cash equivalent reward.

2. The method of claim 1, further comprising:
retrieving a catalog of cash equivalent rewards on the mobile device.

3. The method of claim 1, wherein transmitting the request message comprises:
transmitting a phone number of the mobile device to the reward fulfillment server.

4. The method of claim 1, wherein retrieving the barcode image comprises:
activating the link to the barcode image; and
transmitting the barcode image to the mobile device.

5. The method of claim 1, wherein receiving a message on the mobile device comprises receiving a short message service (SMS) message.

6. The method of claim 1, further comprising:
receiving an available point balance of a user, where points are used to redeem the cash equivalent reward.

7. A mobile device comprising:
a processor;
an input interface to receive a selection of a cash equivalent reward;
a network interface to transmit a request message from the mobile device to a reward fulfillment server, wherein the request message comprises the selection of the cash equivalent reward, and wherein the network interface is to receive a message from the reward fulfillment server comprising a link to a barcode image representing the cash equivalent reward;
a browser application to retrieve the barcode image; and
a display device to present the barcode image to a merchant scanning system for redemption of the cash equivalent reward.

8. The mobile device of claim 7, wherein the browser application is to retrieve a catalog of cash equivalent rewards.

9. The mobile device of claim 7, wherein the message from the reward fulfillment server comprises a short message service (SMS) message.

10. The mobile device of claim 7, wherein the request message comprises a phone number of the mobile device.

11. The mobile device of claim 7, wherein the link further comprises an identification number of the cash equivalent reward.

12. The mobile device of claim 7, wherein the display device is to display an available point balance of a user, wherein points are used to redeem the cash equivalent reward.

13. The mobile device of claim 7, wherein the barcode image is configured to interface with the merchant scanning system.

14. A computer-readable medium with instructions stored thereon which, when executed by a processor perform a method, the method comprising:
receiving a selection of a cash equivalent reward on a mobile device;
transmitting a request message from the mobile device to a reward fulfillment server, wherein the request message comprises the selection of the cash equivalent reward;
receiving a message on the mobile device from the reward fulfillment server comprising a link to a barcode image, wherein the barcode image represents the cash equivalent reward;
retrieving the barcode image; and
presenting the barcode image to a merchant scanning system to redeem the cash equivalent reward.

15. The computer-readable medium of claim 14, the method further comprising:
retrieving a catalog of cash equivalent rewards on the mobile device.

16. The computer-readable medium of claim 14, wherein transmitting the request message comprises:
transmitting a phone number of the mobile device to the reward fulfillment server.

17. The computer-readable medium of claim 14, wherein retrieving the barcode image comprises:
activating the link to the barcode image; and
transmitting the barcode image to the mobile device.

18. The computer-readable medium of claim 14, wherein receiving a message on the mobile device comprises receiving a short message service (SMS) message.

19. The computer-readable medium of claim 14, the method further comprising:
receiving an available point balance of a user, where points are used to redeem the cash equivalent reward.

20. The computer-readable medium of claim 14, wherein the transmitting a request message comprises transmitting an Extensible Markup Language (XML) message.
